(19) United States
(12) Patent Application Publication
(10) Pub. No.: US 2009/0313437 A1
(43) Pub. Date: Dec. 17, 2009

(54) METHOD AND SYSTEM OF OPTIMAL CACHE PARTITIONING IN IPTV NETWORKS

(75) Inventors: Lev B. Sofman, Allen, TX (US); Bill Krogfoss, Frisco, TX (US); Anshul Agrawal, Plano, TX (US)

Correspondence Address: RG and Associates, 1103 Twin Creeks, Allen, TX, 75013, US

(73) Assignee: ALCATEL-LUCENT USA INC., Murray Hill, NJ (US)

(21) Appl. No.: 12/542,838

(22) Filed: Aug. 18, 2009

Related U.S. Application Data
(63) Continuation-in-part of application No. PCT/US08/10269, filed on Aug. 29, 2008.
(60) Provisional application No. 61/201,525, filed on Dec. 11, 2008.
(60) Provisional application No. 60/969,162, filed on Aug. 30, 2007.

(51) Int. Cl. G06F 12/08; G06F 12/02

(52) U.S. Cl. 711/129; 711/170; 711/E12.002; 711/E12.017

(57) ABSTRACT

In an IPTV network, one or more caches may be provided at the network nodes for storing video content in order to reduce bandwidth requirements. Cache functions such as cache effectiveness and cacheability may be defined and optimized to determine optimal partitioning of cache memory for caching the unicast services of the IPTV network.

### CROSS REFERENCE TO RELATED APPLICATIONS

This application claims the benefit of U.S. Provisional Application No. 61/201,525 filed Dec. 11, 2008, and claims the benefit of and is filed as a continuation-in-part of PCT Patent Application No. PCT/US08/10269 filed Aug. 29, 2008, which is based upon and claims priority to U.S. Provisional Application No. 60/969,162 filed Aug. 30, 2007, the entire contents of all of which are incorporated herein by reference.

### FIELD OF THE INVENTION

This invention relates to Internet Protocol Television (IPTV) networks and in particular to caching of video content at nodes within the network.

### BACKGROUND OF THE INVENTION

In an IPTV network, Video on Demand (VOD) and other video services generate large amounts of unicast traffic from a Video Head Office (VHO) to subscribers and, therefore, require significant bandwidth and equipment resources in the network. To reduce this traffic, and subsequently the overall network cost, part of the video content, such as most popular titles, may be stored in caches closer to subscribers. For example, a cache may be provided in a Digital Subscriber Line Access Multiplexer (DSLAM), Central Office (CO) or in Intermediate Offices (IO). Selection of content for caching may depend on several factors including size of the cache, content popularity, etc.

What is required is a system and method for optimizing the size and locations of cache memory in IPTV networks, and in particular a process to optimally partition a cache between several video services with different traffic characteristics and content sizes.

### SUMMARY OF THE INVENTION

In one aspect of the disclosure, there is provided a method for optimizing a cache memory allocation of a cache relative to a plurality of services available to the cache, the cache at a network node of an Internet Protocol Television (IPTV) network, the method comprises defining a total cache effectiveness function, and determining an optimal solution to the total cache effectiveness function.

In one aspect of the disclosure, there is provided, in an Internet Protocol Television network having a plurality of services, a network node comprising a cache having a memory, wherein a partitioning of the cache memory to cache the plurality of services is in accordance with an optimal solution of a plurality of cacheability functions each corresponding to a respective service, the optimal solution specifying a determination of a cacheability value for the plurality of cacheability functions that concurs with occurrence of a cache limiting condition.

In one aspect of the disclosure, there is provided a computer-readable medium comprising computer-executable instructions for execution by a processor, that, when executed, cause the processor to process a plurality of cacheability functions each characterizing a respective service available for caching at a cache at a network node of an IPTV network, and optimize the cacheability functions.

### BRIEF DESCRIPTION OF THE DRAWINGS

Reference will now be made to specific embodiments, presented by way of example only, and to the accompanying drawings in which:

FIG. 1 is a schematic diagram of a typical cache architecture in a video network;

FIG. 2 is a graphical depiction of a process for determining an optimal caching solution involving the cacheability functions of two services;

FIG. 3 is a flow diagram depicting a sequence of operations for implementing an optimizing cache allocation scheme; and

FIG. 4 is a schematic illustration of a computing facility for executing the process of FIG. 3.

### DETAILED DESCRIPTION OF THE INVENTION

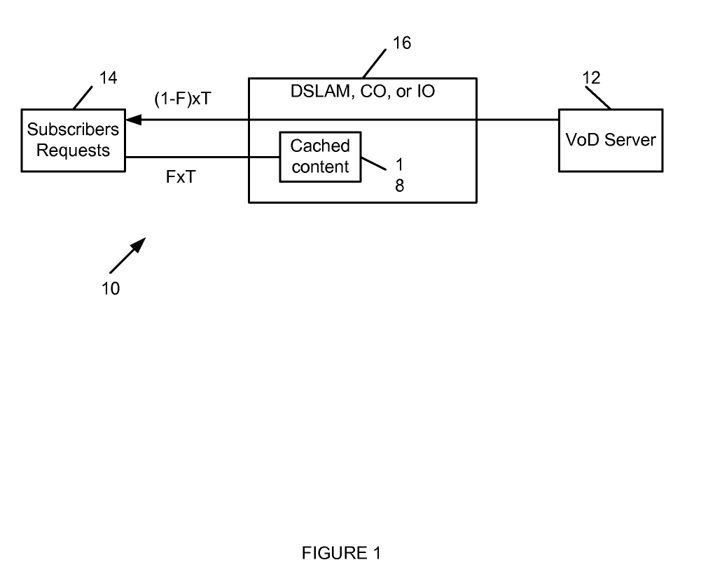

FIG. 1 illustrates a cache configuration in a typical IPTV system 10. In system 10, a content provider such as VoD server 12 delivers video content to an end user 14 (subscriber request locations) via intermediate routing networks 16, such as DSLAM, CO, or IO. To facilitate the delivery of VoD content and enhance video traffic throughput, part of the video content may be stored in caches closer to the subscribers. For example, caches may be provided in some or all of the DSLAMs, COs or IOs. In one embodiment, a cache may be provided in the form of a cache module 18 that can store a limited amount of data, e.g. up to 3000 TeraBytes (TB). In addition, each cache module may be able to support a limited amount of traffic, e.g. up to 20 Gbs.

In one embodiment, caches are provided in all locations of one of the layers, e.g. DSLAM, CO, or IO. That is, a cache will be provided in each DSLAM 14 of the network, or each CO 16 or each IO 18.

FIG. 1 exemplifies how a typical cache works. Out of total amount of traffic T requested by subscribers 14, some portion F×T of this traffic is served from the cache 18, while the remaining part (1−F)×T is delivered from upstream, e.g., VoD server 12 in VHO. The effectiveness of each cache may be described as the percentage of video content requests that may be served from the cache, as expressed by the function F.

Cache effectiveness (or cache hit ratio) F=F(n), is a function of the number n of cached titles. This function depends on statistical characteristics of traffic (e.g., long- and short-term popularity of titles) and on the effectiveness of the caching algorithm to update the cache content. Cache effectiveness, then, depends on several factors, including the number of titles stored in the cache (which is a function of cache memory and video sizes) and the popularity of titles stored in the cache which can be described by a popularity distribution.

Different video and other services may have different cache effectiveness functions. For example, different video services, such as Fast Channel Change (FCC), VoD, Network Personal Video Recorder (NPVR), and Pause Live TV (PLTV), have different cache effectiveness (or hit rates) and different size of titles. A problem to be addressed is how can a limited resource, i.e., cache memory, be partitioned between different services in order to increase the overall cost effectiveness of caching.

Accordingly, a goal, for a given set of services, is to maximize total cache effectiveness subject to the limits of available cache memory M and cache traffic throughput T. In one embodiment, cache effectiveness is defined as a total cache hit rate weighted by traffic amount. In an alternative embodiment, cache effectiveness may be weighted with minimization of used cache memory.

The problem of optimal partitioning of cache memory between several unicast video services may be considered as a constraint optimization problem similar to the “knapsack problem”, and may be solved by, e.g., a method of linear integer programming. However, given the number of variables described above, finding a solution may take significant computational time.

Thus, in one embodiment of the disclosure, the computational problem is reduced by defining a special metric—“cacheability” (Cab)—to speed-up the process of finding the optimal solution. The cacheability metric takes into account cache effectiveness, total traffic, and size of one title per service. The method uses the cacheability metric and an iterative process to find the optimal number of cached titles (for each service) that will maximize overall cache hit rate, subject to the constraints of cache memory and throughput limitations.

In order to develop the cacheability metric, a methodology is first needed to characterize the behavior or performance of a cache, and in particular a means to characterize cache effectiveness.

Total cache effectiveness is defined by the total amount of traffic served from the cache at peak time. The maximization of total cache effectiveness (i.e., maximize the total amount of traffic served from the cache), can be expressed as a constraint optimization problem, namely:

$$max {\sum }_{i = 1}^{n} {T}_{i} {F}_{i} ( ⌊ {M}_{i} / {S}_{i} ⌋ )$$

subject to cache memory constraint:

$${\sum }_{i = 1}^{N} {M}_{i} \leq M$$

and cache throughput constraint:

$${\sum }_{i = 1}^{N} {T}_{i} {F}_{i} ( ⌊ {M}_{i} / {S}_{i} ⌋ ) \leq T$$

where:
└x┘ is max integer that <x;
N is the total number of services;
M is an available cache memory;
T is the maximum cache traffic throughput;
Tᵢ is the traffic for the i-th service, i=1, 2, . . . , N;
Fᵢ(n) is the cache effectiveness as a function of number of cached titles n, for the i-th service, i=1, 2, . . . , N;
Mᵢ is the cache memory occupied by titles of the i-th service, i=1, 2, . . . , N; and
Sᵢ is the size per title for the i-th service, i=1, 2, . . . , N.

The cache effectiveness function Fᵢ(n) is the ratio of traffic for the i-th service that may be served from the cache if n items (titles) of this service may be cached. This function is closely related to content popularity CDF (cumulative density function). In particular, Fᵢ(0)=0 and Fᵢ(nᵢ)=1, where nᵢ is a total number of titles for the i^{th} service.

This constraint optimization problem, which is a form of knapsack problem, may be formulated as a Linear Integer Program and solved by LP Solver.

If there are several optimal solutions for this problem, the solution that uses the least amount of cache memory would be preferred.

Continuous formulation of this problem is similar to the formulation above:

$$max {\sum }_{i = 1}^{n} {T}_{i} {F}_{i} ( {M}_{i} / {S}_{i} )$$

subject to

$${\sum }_{i = 1}^{N} {M}_{i} \leq M$$

and

$${\sum }_{i = 1}^{N} {T}_{i} {F}_{i} ( {M}_{i} / {S}_{i} ) \leq T$$

and may be solved using a Method of Lagrange Multipliers. The Lagrange multipliers method is used for finding the extrema of a function of several variables subject to one or more constraints and is a basic tool in nonlinear constrained optimization. Lagrange multipliers compute the stationary points of the constrained function. Extrema occur at these points, or on the boundary, or at points where the function is not differentiable.

Assuming that the cache effectiveness functions Fᵢ are differentiable, and by applying the method of Lagrange multipliers to the problem, the resulting equation is:

$$\frac{d}{d Mi} ( {\sum }_{i = 1}^{N} {T}_{i} {F}_{i} ( {M}_{i} / {S}_{i} ) - {λ}_{1} ( {\sum }_{i = 1}^{N} {M}_{i} - M ) - {λ}_{2} ( {\sum }_{i = 1}^{N} {T}_{i} {F}_{i} ( {M}_{i} / {S}_{i} ) - T ) ) = 0$$

or

$$\frac{{T}_{i}}{{S}_{i}} \frac{d {F}_{i}}{d {M}_{i}} ( \frac{{M}_{i}}{{S}_{i}} ) = \frac{{λ}_{1}}{1 - {λ}_{2}}$$

for i=1, 2, . . . , N.

These equations describe stationary points of the constraint function. An optimal solution may be achieved at stationary points or on the boundary (e.g., where Mᵢ=0 or Mᵢ=M).

According to the last equation above, at the stationary point, two or more services that share the memory should be “balanced,” that is, have the same value of functions (i.e., the left side of the reduced Lagrange Multiplier equation):

$${f}_{i} ( m ) \frac{{T}_{i}}{{S}_{i}} \frac{d {F}_{i}}{d m} ( \frac{m}{{S}_{i}} )$$

These functions fᵢ(m) are called the “cacheability” functions, and serve as the metric used to facilitate a determination of the optimal solution for partitioning or allocating the cache memory among various services. The functions quantify the benefit of caching the i-th service per unit of used memory (m) (i=1, 2, . . . , N).

The function

$$\frac{d {F}_{i}}{d m}$$

is closely related to the content popularity PDF (probability density function) for the i-th service. This function decreases with increases of m. Therefore, for given parameters T and S (throughput and size per title, respectively), the cacheability function fᵢ(m) also decreases when m increases.

The cacheability functions fᵢ(m) can now be used to determine how to optimally partition or allocate a cache between several video services with different traffic characteristics and content sizes.

For exemplary purposes, in order to illustrate how cacheability functions may be used to find the optimal solution to the constraint optimization problem, an illustrative scenario is provided having two services with cacheability functions f₁(m) for the 1^{st} service and f₂(m) for the 2^{nd} service. It should be apparent, though, that the optimal partition determination can be extended to any number of services.

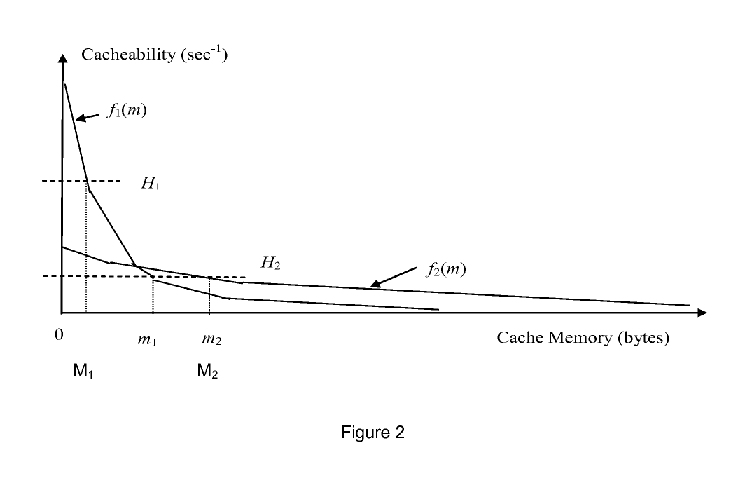

For purposes of this scenario, reference is made to FIG. 2, which graphically depicts illustrative cacheability functions f₁(m) and f₂(m).

Assume, for example, that M₁ units of cache memory is used for the 1^{st} service and M₂ units of cache memory is used for the 2^{nd} service. The total caching benefit of both services, which is the amount of traffic T_{c} served from the cache, can be computed as follows:

$${T}_{c} = {\int }_{0}^{{M}_{1}} {f}_{1} ( m ) d m + {\int }_{0}^{{M}_{2}} {f}_{2} ( m ) d m$$

Two cases are considered: a cache memory limited case, and a cache throughput limited case.

First, consider the case when T_{c}<T, and M₁+M₂=M (i.e., cache memory limited case). If f₁(M₁)>f₂(M₂), as shown in FIG. 2, then, according to the optimizing algorithm of the invention, caching benefit T_{c} may be increased by “trading” a small amount of memory Δm of the 2^{nd} service for the same amount of memory for the 1^{st} service. In this manner, M₁+Δm units of cache memory would be used for the 1^{st} service, while M₂−Δm units of cache memory would be used for the 2^{nd} service. While the total cache memory used would be the same, the new formulation of the caching benefit would be:

$${T}_{c}^{′} = {\int }_{0}^{{M}_{1} + Δ m} {f}_{1} ( m ) d m + {\int }_{0}^{{M}_{2} - Δ m} {f}_{2} ( m ) d m$$

This new caching benefit T_{c}′ is more than the original T_{c} (for small Δm), because f₁(m₁)>f₂(m₂) for m₁ε[M₁,M₁+Δm] and m₂ε[M₂,M₂−Δm].

This reasoning demonstrates that if there is a solution where both services share the cache memory, then the optimal solution occurs when the solution is balanced, namely, when the cacheability values of the services in the optimal solution should be equal, i.e., each of the cacheability functions fᵢ(m) has substantially the same value. This balancing condition suggests that the optimal solution will occur at the intersection point(s) of the cacheability curves with a horizontal line, since such a line graphically marks off points of equal cacheability values for the different cacheability functions.

Second, consider the alternate case with T_{c}=T, M₁+M₂≦ΔM, and f₁(M₁)>f₂(M₂), i.e., a cache throughput limited case. By similar reasoning as above in the cache memory limited case, it can be demonstrated that by “trading” a small amount of memory it is possible to achieve a comparatively “better” optimal solution, since even though there is the same amount of cache throughput T_{c}, less amount of cache memory is used.

The memory “trading” strategy, whether applied to the memory-limited or throughput-limited scenario, facilitates implementation of an iterative algorithm for determining an optimal cache partitioning, namely, to determine how much of the cache memory will be allocated to each service having cached content.

The algorithm can be further understood in reference to FIG. 2, depicting two illustrative services having cacheability functions f₁(m) and f₂(m). For purposes of demonstrating the algorithm, the cacheability functions f₁ and f₂ are plotted on the same chart.

According to the algorithm, for every horizontal line (horizon) that intersects the cacheability curve(s), a determination is made regarding the corresponding amount of cache memory used (i.e., by indications along the horizontal axis), as well as the corresponding traffic throughput.

As the horizon moves down, the amount of cache memory used and traffic throughput increases. This movement of the horizon, which implements the memory “trading” strategy, is continued in a dynamic iterative fashion until either the cache memory limit or cache traffic limit is reached, whichever occurs first. The optimal partitioning solution is specified by occurrence of this limiting condition. In particular, the various memory points specified by the intersection of this limit-reaching horizontal line with the cacheability curves define the allocation scheme for partitioning the cache among the services. The memory values corresponding to the intersection points indicate, for each respective cacheability function (and related video service), the amount of memory that will be allocated to that service in the cache memory.

For example, depending on the shape of the cacheability curves, the optimal solution may be achieved when the horizon intersects (a) one curve only, such as horizon H₁ intersecting just cacheability curve f₁(m), or (b) both curves, such as horizon H₂ intersecting curves f₁(m) and f₂(m), i.e., the balancing condition.

In case (a), cache memory would be allocated entirely to the service defined by cacheability function f₁(m), i.e., memory amount M₁ is dedicated to the service for function f₁(m), and none to the service for function f₂(m).

In case (b), the cache memory would be shared in some proportion among the services for both cacheability functions f₁(m) and f₂(m). For example, the cache memory would allocate a memory amount m₁ to the service for function f₁(m) (i.e., the memory amount corresponding to the intersection of horizon H₂ with curve f₁(m)), and a memory amount m₂ to the service for function f₂(m) (i.e., the memory amount corresponding to the intersection of horizon H₂ with curve f₂(m)). In this case, there is a balancing among cacheability functions f₁(m) and f₂(m), since the optimal solution occurs at an equivalent cacheability value for each function.

A discrete version of this algorithm can be used to develop a cache partitioning tool that optimally configures cache memory for a given set of services.

The utility of the optimizing algorithm may be demonstrated with a further example. Assume three services: FCC, VoD, and NPVR having popularity distributions that can be characterized as Zipf-Mandelbrot (ZM) curves with different α values (power parameter) and q values (“shift” factor). Each of the three services can be fully characterized by a certain number of titles, size of titles, and ZM distribution parameters, such as in the exemplary profiles of Table 1 below.

TABLE 1
Characteristics of services

| Services | # Titles | Title Size (Mb) | Power | Shift |
|---|---|---|---|---|
| FCC | 210 | 5 | 1.0 | 0 |
| VoD | 5,000 | 2,700 | 0.5 | 100 |
| NPVR | 50,000 | 1,800 | 0.4 | 0 |

In addition to these characteristics, the traffic volume generated by each service also needs to be taken into account. For illustrative purposes, the following cache characteristics are used as memory and traffic constraints: the maximum size of the cache is 3TB, and the maximum cache throughput is 20 Gbps. Given these constraints, the cache partitioning optimizing algorithm is applied to two scenarios involving the services of Table 1, in which the only difference is the volume of traffic generated by FCC.

Table 2 shows the results of a first scenario.

TABLE 2
Optimal cache configuration for scenario 1.

| | Traffic | # Items Stored | Traffic from | Memory |
|---|---|---|---|---|
| Services | (Mbs) | (titles) | cache (Mbs) | Occupied (MB) |
| FCC | 10,950 | 210 | 10,950 | 1,050 |
| VoD | 5,840 | 1,037 | 2,255 | 2,799,900 |
| NPVR | 6,753 | 110 | 166 | 198,000 |
| TOTAL | | | 13,370 | 2,998,950 |

As shown in Table 2, the optimal cache partitioning solution results in almost all of the available cache memory to be used (2,998,950 MB versus 3,000,000 MB available), while the total traffic from the cache is below its limit of 20 Gbps. This scenario can be considered a memory constrained case, since the total caching benefit is limited by the available cache memory. For example, referring to the horizon-moving strategy of FIG. 2 as applied to the services of Table 1, the movement of the horizontal line would be terminated by reaching the limit of cache memory. The final horizontal line at this memory limit condition would then specify the memory allocations in Table 2, namely, the individual memory values correspond to intersection points of the final horizontal line with the respective cacheability functions fᵢ(m).

Table 3 shows the results of a second scenario.

TABLE 3
Optimal cache configuration for scenario 2.

| | Traffic | # Items Stored | Traffic from | Memory |
|---|---|---|---|---|
| Services | (Mbs) | (titles) | cache (Mbs) | Occupied (MB) |
| FCC | 21,900 | 125 | 19,989 | 625 |
| VoD | 5,840 | 0 | 0 | 0 |
| NPVR | 6,753 | 0 | 0 | 0 |
| TOTAL | | | 19,989 | 625 |

As shown in Table 3, in which FCC traffic volume is doubled, the optimal cache partitioning solution generates traffic from the cache close to its limit of 20 Gbps, while there is unoccupied space in cache memory. This scenario can be considered a throughput constrained case, since the total caching benefit is limited by the available cache throughput.

It is notable that in scenario 1 (Table 2), titles from all three services reside in the cache (see “# Items Stored” column), including all of the FCC titles. By comparison, in scenario 2 (Table 3), only some titles from the FCC service are stored in the cache (125), while none are stored from the other two services, since the cache throughput limit has been reached just by accommodating the FCC service.

One feature of the cache allocation scheme is that the optimizing algorithm can be executed on an ongoing, dynamic basis as system requirements change. For example, referring to Tables 2 and 3, as the specifications changed regarding the FCC traffic, the appropriate calculations would be made to generate new cacheability functions required by the new data, a new total caching benefit would be computed, and the optimizing algorithm would be applied to the new total caching benefit expression. This adaptiveness to changing circumstances ensures that the cache is partitioned appropriately, with cache memory dedicated to each service in order to optimize the cache performance.

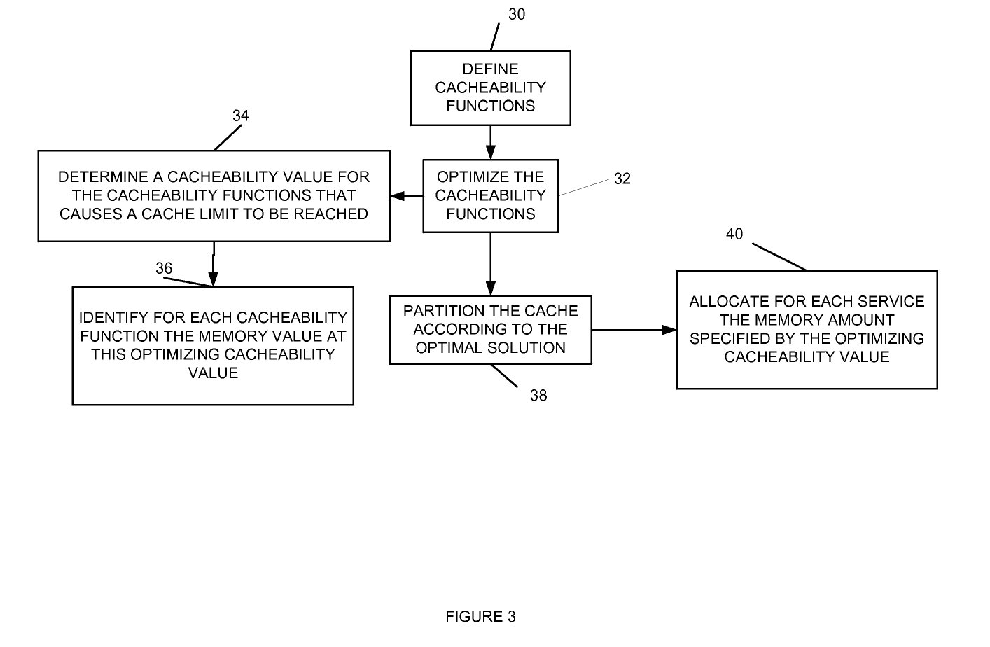

FIG. 3 shows a high-level flow diagram illustrating one form of the optimization process. A cacheability function is defined for each service that is available for caching (step 30). The cacheability functions are optimized (step 32). This optimization is conducted by determining a cacheability value for the cacheability functions that results in a cache limit being reached, e.g., a cache memory limit or a cache throughput limit (step 34). At this optimizing condition, the memory values for each cacheability function are identified (step 36). In particular, for each cacheability function, the memory value is identified (x-axis point) that corresponds to the cacheability value (y-axis point) that concurs with reaching the cache limit. These memory values specify the scheme for partitioning the cache among the services (steps 38, 40).

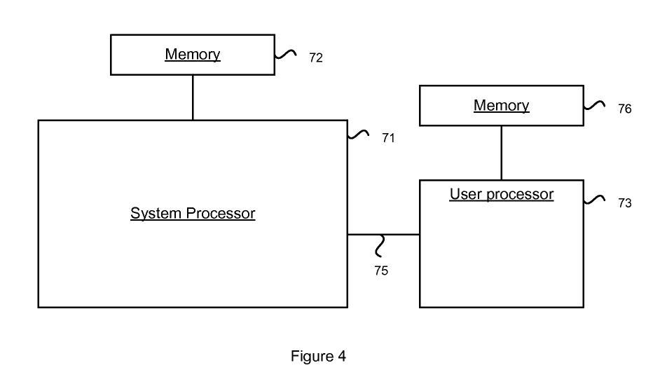

In one embodiment, the optimization tool for implementing the cache partitioning scheme may be embodied on one or more processors as shown in FIG. 4. A first processor 71 may be a system processor operatively associated with a system memory 72 that stores an instruction set such as software for calculating a cacheability function (fᵢ(m)) and/or a cache effectiveness function (Fᵢ(n)). The system processor 71 may receive parameter information from a second processor 73, such as a user processor which is also operatively associated with a memory 76. The memory 76 may store an instruction set that when executed allows the user processor 73 to receive input parameters and the like from the user. A calculation of the cacheability function and/or the cache effectiveness function may be performed on either the system processor 71 or the user processor 73.

For example, input parameters from a user may be passed from the user processor 73 to the system processor 71 to enable the system processor 71 to execute instructions for performing the calculation. Alternatively, the system processor may pass formulas and other required code from the memory 72 to the user processor 73 which, when combined with the input parameters, allows the processor 73 to calculate cacheability functions and/or the cache effectiveness function.

The input parameters may include, but are not limited to, characteristics of the various services (e.g., number of items offered by the service, item size, ZM distribution parameters, popularity distributions for the items, traffic specifications); cache constraints (memory and throughput); and statistical characteristics of the traffic for each service.

It will be understood that additional processors and memories may be provided and that the calculation of the cache functions may be performed on any suitable processor. In one embodiment, at least one of the processors may be provided in a network node and operatively associated with the cache of the network node so that, by ongoing calculation of the cache functions, the cache partitioning can be maintained in an optimal state.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method for optimizing a cache memory allocation of a cache relative to a plurality of services available to the cache, the cache at a network node of an Internet Protocol Television (IPTV) network, the method comprising:
defining a total cache effectiveness function; and
determining an optimal solution to the total cache effectiveness function.

2. The method according to claim 1 wherein:
defining the total cache effectiveness function comprises defining a function
$${\sum }_{i = 1}^{n} {T}_{i} {F}_{i} ( ⌊ {M}_{i} / {S}_{i} ⌋ ) ;$$
and
determining the optimal solution comprises determining a solution to the expression
$$max {\sum }_{i = 1}^{n} {T}_{i} {F}_{i} ( ⌊ {M}_{i} / {S}_{i} ⌋ ) ,$$
subject to a cache memory constraint
$${\sum }_{i = 1}^{N} {M}_{i} \leq M ,$$
and a cache throughput constraint
$${\sum }_{i = 1}^{N} {T}_{i} {F}_{i} ( ⌊ {M}_{i} / {S}_{i} ⌋ ) \leq T ,$$
where:
└x┘ is max integer that <x;
N is the total number of services;
M is an available cache memory;
T is the maximum cache traffic throughput;
Tᵢ is the traffic for the i-th service, i=1, 2, . . . , N;
Fᵢ(n) is the cache effectiveness as a function of the number of cached items n, for the i-th service, i=1, 2, . . . , N;
Mᵢ is the cache memory occupied by items of the i-th service, i=1, 2, . . . , N; and
Sᵢ is the size per item for the i-th service, i=1, 2, . . . , N.

3. The method according to claim 2 wherein determining the solution to the expression
$$max {\sum }_{i = 1}^{n} {T}_{i} {F}_{i} ( ⌊ {M}_{i} / {S}_{i} ⌋ )$$
comprises:
applying a method of Lagrange multipliers.

4. The method according to claim 3 wherein applying the method of Lagrange multipliers comprises:
formulating the equations
$$\frac{{T}_{i}}{{S}_{i}} \frac{d {F}_{i}}{d {M}_{i}} ( \frac{{M}_{i}}{{S}_{i}} ) = \frac{{λ}_{1}}{1 - {λ}_{2}} ,$$
for i=1, 2, . . . , N;
where λ₁ and λ₂ are Lagrange Multipliers.

5. The method according to claim 4 further comprises:
defining a plurality of cacheability functions
$${f}_{i} ( m ) = \frac{{T}_{i}}{{S}_{i}} \frac{d {F}_{i}}{d m} ( \frac{m}{{S}_{i}} ) ,$$
for i=1, 2, . . . , N; and
optimizing the plurality of cacheability functions.

6. The method according to claim 5 wherein optimizing the plurality of cacheability functions comprises:
determining a cacheability value for the plurality of cacheability functions that coincides with occurrence of a cache limiting condition.

7. The method according to claim 5 wherein optimizing the plurality of cacheability functions comprises:
determining a cacheability value for the plurality of cacheability functions that yields attainment of at least one of a cache memory limit and a cache traffic limit.

8. The method according to claim 7 comprises:
allocating the cache memory to the plurality of services by using a memory amount for each service corresponding to the cacheability value determination.

9. The method according to claim 1 wherein determining the optimal solution comprises:
defining a plurality of cacheability functions each corresponding to a respective service; and
optimizing the plurality of cacheability functions.

10. The method according to claim 9 comprises:
partitioning the cache memory among the plurality of services according to results obtained from the optimization of the cacheability functions.

11. The method according to claim 9 wherein optimizing the cacheability functions comprises:
determining a cacheability value for the plurality of cacheability functions that concurs with occurrence of a cache limiting condition.

12. The method according to claim 9 wherein defining the cacheability functions comprises:
defining a function
$${f}_{i} ( m ) = \frac{{T}_{i}}{{S}_{i}} \frac{d {F}_{i}}{d m} ( \frac{m}{{S}_{i}} ) ,$$
for i=1, 2, . . . , N;
where:
N is the total number of services;
Tᵢ is the traffic for the i-th service, i=1, 2, . . . , N;
Fᵢ is the cache effectiveness as a function of the number of cached items n, for the i-th service, i=1, 2, . . . , N;
m is a variable specifying the cache memory occupied by items of the i-th service, i=1, 2, . . . , N; and
Sᵢ is the size per item for the i-th service, i=1, 2, . . . , N.

13. The method according to claim 1 wherein defining the total cache effectiveness function comprises:
defining a plurality of cacheability functions
$${f}_{i} ( m ) = \frac{{T}_{i}}{{S}_{i}} \frac{d {F}_{i}}{d m} ( \frac{m}{{S}_{i}} ) ,$$
for i=1, 2, . . . , N; and
defining a traffic metric indicating the amount of traffic served from the cache, using the plurality of cacheability functions;
where:
N is the total number of services;
Tᵢ is the traffic for the i-th service, i=1, 2, . . . , N;
Fᵢ is the cache effectiveness as a function of the number of cached items n, for the i-th service, i=1, 2, . . . , N;
m is a variable specifying the cache memory occupied by items of the i-th service, i=1, 2, . . . , N; and
Sᵢ is the size per item for the i-th service, i=1, 2, . . . , N.

14. The method according to claim 13 wherein determining the optimal solution comprises:
optimizing the traffic metric.

15. The method according to claim 13 wherein defining the traffic metric comprises:
defining a traffic throughput T_{c},
where
$${T}_{c} = \sum {\int }_{0}^{{m}_{i}} {f}_{i} ( m ) d m ,$$
for i=1, 2, . . . , N;
where mᵢ is a variable cache memory amount for the i-th service.

16. The method according to claim 15 comprises:
optimizing the traffic throughput T_{c} by varying the relevant mᵢ for each respective integral operation until a cache limit condition is reached.

17. In an Internet Protocol Television network having a plurality of services, a network node comprising a cache having a memory, wherein a partitioning of the cache memory to cache the plurality of services is in accordance with an optimal solution of a plurality of cacheability functions each corresponding to a respective service, the optimal solution specifying a determination of a cacheability value for the plurality of cacheability functions that concurs with occurrence of a cache limiting condition.

18. The network node according to claim 17 wherein the optimal solution implements a process, the process comprises:
defining each cacheability function with an expression
$${f}_{i} ( m ) = \frac{{T}_{i}}{{S}_{i}} \frac{d {F}_{i}}{d m} ( \frac{m}{{S}_{i}} ) , for i = 1 , 2 , … , N ;$$
defining a traffic metric indicating the amount of traffic served from the cache, using the plurality of cacheability functions; and
optimizing the traffic metric, subject to a cache memory constraint and a cache throughput constraint;
where:
N is the total number of services;
Tᵢ is the traffic for the i-th service, i=1, 2, . . . , N;
Fᵢ is the cache effectiveness as a function of the number of cached items n, for the i-th service, i=1, 2, . . . , N;
m is a variable specifying the cache memory occupied by items of the i-th service, i=1, 2, . . . , N; and
Sᵢ is the size per item for the i-th service, i=1, 2, . . . , N.

19. A computer-readable medium comprising computer-executable instructions for execution by a processor, that, when executed, cause the processor to:
process a plurality of cacheability functions each characterizing a respective service available for caching at a cache at a network node of an IPTV network; and
optimize the cacheability functions.

20. The computer-readable medium according to claim 19 wherein the instructions further cause the processor to:
perform the optimization by determining a cacheability value for the cacheability functions that yields a cache limit condition event.
